(19) United States
(12) Patent Application Publication
(10) Pub. No.: US 2016/0121371 A1
(43) Pub. Date: May 5, 2016

(54) STRIPPING SYSTEM

(71) Applicant: BÜHLER AG, Uzwil (CH)

(72) Inventor: Tobias NÜSSLE, Konstanz (DE)

(21) Appl. No.: 14/893,698

(22) PCT Filed: May 13, 2014
(86) PCT No.: PCT/EP2014/059697

§ 371 Date: Nov. 24, 2015

(30) Foreign Application Priority Data
May 31, 2013 (EP) 13169975.3

(51) Int. Cl. B08B 1/00

(52) U.S. Cl. CPC B08B 1/005

(57) ABSTRACT

A blade bar (2) for a stripping system (10) for stripping a product from a roller in a roller mill, to a blade holding system (20), and to a stripping system (10). A pressure element (6) is provided for securing the blade in the blade bar, the pressure element is arranged within the blade bar. The blade bar (2) has a line (3) for conducting a fluid, by which pneumatic or hydraulic pressure can be built up in order to secure the stripping blade (1) on the blade bar (2).

The invention relates to a blade bar for a stripping system for stripping product from a roller in a roiling mill for applying a stripping blade to a roller, to a blade holder system for a stripping system, and to a stripping system.

In roller mills and roiling mills which serve to pulverize in particular pasty roiling stock, it is customary to strip the pulverized grinding stock from a roller with a stripping blade and to then lead it into a collecting vessel. In particular on known five-roller mills for the fine grinding of cocoa masses or chocolate masses, a stripping blade is snugly fitted to the last, i.e. the fifth roller. Every effort is made to fully remove the product which after the last nip adheres to the last roller, in order to prevent winding of product.

The known stripping mechanism which is used herein contains three components: a blade bar, a blade holder and the actual stripping blade or “blade”. Only the tip of the blade has contact with the roller.

The blade bar is forced with a pressing screw, a lever device, hydraulically or pneumatically against the roller, wherein the setting angle is generally adjustable. Moreover, the blade bar is generally arranged displaceably and/or pivotably and can be brought into a position in which the stripping blade can be changed.

As the blade is normally used a spring steel band, which is supplied on rolls and, according to requirement (for example roller length of the rolling mill), is cut off from the roll in suitable length.

The service life of the blade depends on the nature of the product to be processed, which product must be stripped from the roller. The higher is the cocoa content of the cocoa mass or chocolate mass, for instance, the more rapidly does the blade wear down as a result of abrasion.

If a play exists between blade and blade holder, then vibrations of the blade, and, in the worst case, untidy stripping of the grinding stock from the grinding roller, can ensue.

From EP2341781, a stripping system in which the blade is clamped in the clamp bar with a spring-loaded clamping system is known. Preferably, double sprung toggle levers are used to clamp the blade.

The clamping force acts in the immediate environment of the toggle lever. For a uniform clamping and a vibration-free mounting of the blade in the clamping bar, according to the length of the stripping blade a whole host of toggle levers must be used, which, for the clamping or release, either have to be operated individually in turn or must be mechanically connected.

The object of the invention is to avoid the drawbacks of the prior art and to provide a rapidly changeable and easily usable stripping system for a roiling mill.

The object of the invention is achieved by a blade bar for a stripping system for applying a stripping blade to a roller. The blade serves to strip product from a roller in a rolling mill. According to the invention there is provided at least one pressure element, which is disposed within the blade bar and is designed such that it can assume a first state, in which it can help to exert a clamping force for fixing of the stripping blade in the blade bar, and a second state, in which it does not help to exert the clamping force, and in particular the extent of which in the direction of the clamping force is changeable.

With the aid of the pressure element, a stripping blade which is inserted in the blade bar can be clamped against the blade bar, preferably the stripping blade can be clamped between pressure element and blade bar. The pressure element can itself apply a clamping force to the stripping blade or transmit the clamping force to the stripping blade.

A pressure element lying within the blade bar allows a compact construction of the blade bar. The pressure element is at the same time protected by the blade bar, so that it is less prone to dirtying and thus to functional impairment.

The pressure element can change its position or change its extent in order to get from the first into the second state, and vice versa.

The pressure element can be mechanically operable, for instance a wedge element can be displaced or an eccentric can be turned.

The pressure element can be electromagnetically operable, for instance, piezoelectrically driven, can change its extent in the direction of the clamping force.

The pressure element can be an elastic element or a spring element, which, on the basis of its inner tension, exerts a force in the clamping direction and can be compressed, for instance, with a mechanical, hydraulic or pneumatic force.

The pressure element is preferably pneumatically or hydraulically operable, thus can change its extent or position, for instance, on the basis of a pneumatic or hydraulic force.

The blade damping bar can comprise a variety of pressure elements.

The blade bar has a line for conducting a fluid by means of which a pneumatic or hydraulic pressure for fastening the stripping blade to the blade bar can be built up.

Alternatively or additionally, there are provided a plurality of pressure elements, which are coupled with one another so that they ail can be transferred substantially simultaneously from the first into the second state or from the second into the first state.

The coupling can be of mechanical, electromagnetic, hydraulic or pneumatic construction. Preferably, mechanically operable pressure elements are mechanically coupled, and electromagnetically variable pressure elements are coupled via an electric line or a magnetic force.

The coupling can also consist in a mechanical force being transmitted via a fluid substantially simultaneously to a plurality of pressure elements.

The force on the stripping blade can thus be transmitted synchronously at several places on the stripping blade, preferably over the entire length. The stripping blade can in this way be fastened particularly easily, and there is no danger of slippage as one pressure element after another is actuated.

The fluid is constituted either by a gas, in particular compressed air, or by a liquid, for example water or a hydraulic oil, in particular according to DIN 51524. In the processing of foods, a food-compatible oil can also be used.

By means of the line provided in the blade bar, a hydraulic or pneumatic pressure can be built up rapidly and evenly throughout the line.

Preferably, the line is disposed inside the blade bar.

The line can be constituted, by a rigid pipeline, in which a force can be transmitted at the end of the line. Alternatively, the line is flexible or has at least flexible regions which expand upon the build-up of the pneumatic or hydraulic pressure.

The blade bar can have precisely one line or a line system comprising a plurality of lines for conducting the fluid, in which lines the hydraulic or pneumatic pressure can be built up preferably in a temporally coupled manner, in particular in a specific sequence or simultaneously.

In any event, upon the build-up of a pneumatic or hydraulic pressure, namely when the line is filled under pressure with the fluid, a holding force can be generated on a stripping blade to be inserted into the blade bar. As long as the pneumatic or hydraulic pressure is maintained, the holding force also persists.

The pneumatic or hydraulic pressure can be built up practically simultaneously throughout the line system, so that the holding force can be generated synchronously at several locations, in particular at a plurality of pressure elements.

This facilitates and accelerates the assembly of a stripping blade which is generally extended over the entire length of a roller.

The line system can also be arranged such that the holding force builds up gradually along the stripping blade, or firstly at previously defined points.

The arrangement of the line or lines determines the distribution of force over the stripping blade. The more exit points a rigid line system has, or the larger the flexible region of the line is, the more evenly can the force be distributed over the stripping blade.

The blade bar is preferably connectable to a compressed air or hydraulic supply for the creation of a pneumatic or hydraulic pressure. To this end, the line or line system has, in particular, at least one corresponding port, at which the line or line system can be releasably coupled to a pneumatic or hydraulic supply. The supply comprises, for instance, a compressed air dispenser, a hydraulic oil reservoir, a hydraulic pump and/or a hydraulic cylinder.

The rolling mill generally requires further pneumatic or hydraulic systems, for example for pressing the blade bar against the roller to whose supply the blade bar can be connectable.

The connection between the blade bar and the compressed air or hydraulic supply can be fixed or releasable.

For a repair or service, the blade bar is preferably separable from the pneumatic or hydraulic supply.

In addition, the blade bar is preferably connectable to a compressed air or hydraulic control system. Via the control system, pneumatic or hydraulic pressure can be switched on and off and the strength of the holding force to be built up can be adjusted.

The connection between the blade bar and the compressed air or hydraulic control system can be fixed or releasable.

If various stripping blades, flexible lines, flexible or different sealing elements are used, then it can be sensible, moreover, to connect the blade bar to a compressed air or hydraulic regulation system. The pneumatic or hydraulic pressure can then be automatically regulated to a desired value suitable for the particular situation.

The connection, between the blade bar and the compressed air or hydraulic regulation system can be fixed or releasable.

In an advantageous embodiment, the blade bar comprises a basic element and a blade bar insert, wherein the line or line system for conducting the fluid is preferably disposed in the blade bar insert.

The blade bar is generally connected to the roller mill via a device which presses the stripping device against the roller and by which the setting angle is adjustable. Preferably this connection exists to the basic: element, while the stripping blade is held, by the blade bar insert. For a service, a repair, or a coupling of the pneumatic or hydraulic system or changing of the stripping blade, the stripping system, therefore does not necessarily have to be released from the roller mill.

The basic element is responsible for the general stiffness of the stripping system and can be realized as a lightweight component. On the other hand, the blade bar insert can exist in solid construction, in particular when it comprises a rigid line system.

Alternatively, the blade bar insert can be constituted by a fluid-carrying flexible component, which expands when subjected to the force of a fluid.

The blade bar can have precisely one blade bar insert or a plurality of blade bar inserts. The plurality of blade bar inserts can be used jointly to hold a stripping blade and/or for the, in particular alternative, securement of various stripping blades.

In a basic element, various blade bar inserts can be used, for instance inserts having different line systems for the fixing of different stripping blades.

Advantageously, the blade bar comprises a pressure element in the form of a clamping element, which, under the influence of a pneumatic or hydraulic force which can be built up via an appropriate fluid in the line, is movable, in particular in relation to the blade bar insert.

The clamping element couples the pressure built up by the fluid in the line or line system directly or indirectly to the stripping blade. It thus produces a clamping force on the stripping blade and/or the blade holder.

Preferably, the clamping element is constituted, by a stiff strip, which is placed in front of the outlets of the line system that is present in the blade bar insert.

If fluid flows into the line system, then the clamping element is forced away from the line system disposed in the blade bar insert, preferably directly or indirectly against the stripping blade. If, on the other hand, no pneumatic or hydraulic pressure is present, then the clamping element has sufficient play to allow the possible removal, for instance, of the stripping blade.

The line or line system can be bounded by flexible elements which expand and are in contact with the blade bar insert, or the line or line system has openings, so that the fluid enters into direct contact with the blade bar insert. The latter lends itself, above all, to a pneumatic system in which, the leak tightness of the line system is not as critical as, for instance, in a hydraulic system in which hydraulic oil is used as the fluid and which generally has a closed line system.

The blade bar comprises precisely one clamping element, or a plurality of clamping elements, which, in particular, are respectively assigned to a blade bar insert, one or more line openings or one or more flexible line sections.

In a blade bar can be used different blade bar inserts which allow, for instance, a different play and make the stripping system suitable for the insertion of different stripping blades and/or blade holders.

A blade bar insert can possess a profile which only allows the use of a specific stripping blade or blade holder having a corresponding mating profile.

In this way, basically similarly constructed blade bars can be used, for instance, on diverse roller mill types, for which respectively different stripping blades are necessary. For each, roller mill type a profile of the blade bar insert is chosen, so that only the correct stripping blade or the correct blade holder having the corresponding mating profile can be used.

In order to ensure that the clamping element cannot move transversely to the stripping blade and/or blade holder, it is preferably guided. The guidance can be obtained by an appropriate mounting or by guide elements which prevent a movement transversely to the direction of the clamping force. Advantageously there is provided at least one pin, on which the clamping element is movably mounted and is thus guidable, so that a movement of the clamping element is possible only in the axial direction of the pin and thus in the direction of the clamping force or oppositely.

The mounting, in particular the at least one pin, is disposed on the basic element or on the blade bar insert.

The clamping element has preferably, for its part, at least one recess, preferably a circular recess, through which a guide element, in particular the pin, is guided.

Preferably a plurality of guide elements, in particular pins, are provided, so that a parallel guidance is guaranteed and tilting prevented. Accordingly, a plurality of recesses are preferably provided in the clamping element.

In an advantageous embodiment, the blade bar comprises at least one sealing element, in particular an O-ring. Upon the build-up of a hydraulic or pneumatic pressure, the sealing element prevents the escape of fluid from the blade bar. In particular, the sealing element seals the gap between clamping element and blade bar insert or between clamping element and basic element.

In the blade bar, in particular in the blade bar insert, for each sealing element there is preferably provided a recess, into which the sealing element can be placed, in the course of the assembly.

The sealing element is preferably a flexible component, which, upon, the insertion of the stripping blade, in particular between clamping element and blade bar insert, is squeezed.

If a pneumatic or hydraulic pressure is in force, then the clamping element moves, in particular the clamping element moves away from the blade bar insert. In the created gap, the sealing element expands to its original size and in this way ensures that the entire fluid pressure acts on the clamping element—and thus on the stripping blade—and no fluid escapes through the gap between, clamping element and blade bar insert.

To this end, the sealing element is preferably disposed around the openings which the line system has in the blade bar insert. Preferably, each opening is provided with an O-ring.

The object of the invention is additionally achieved by a blade bar, in particular as described, above, which is constructed at least partially in lightweight construction, in particular as an extruded body, in particular the blade bar comprises a basic element which is constructed in lightweight construction, in particular as an extruded body.

Extrusion allows the production of a low-vibration lightweight construction element, which has high stiffness in relation to its mass. The extruded body has a nigh natural frequency.

The blade bar, in particular the basic element, is thus stable, and yet easily fittable.

In a preferred embodiment, a blade bar according to the invention consists at least partially of aluminum, an aluminum alloy or of a fiber composite, in particular a fiber reinforced plastic, for example a carbon fiber reinforced plastic (CFRP) or glass fiber reinforced plastic, in particular the basic element consists of aluminum, an aluminum alloy or of a fiber composite, in particular a fiber reinforced plastic, for example a carbon fiber reinforced plastic (CFRP) or glass fiber reinforced plastic.

Aluminum is a material which is easy to machine and, moreover, is well suited to use in the food sector.

Particularly preferably, the basic element is constructed as an aluminum extruded body.

The object of the invention is additionally achieved by a blade holder system for a stripping system for stripping product from a roller in a roiling mill comprising a blade bar as described above and comprising a blade holder.

The stripping system serves to apply a stripping blade to a roller.

Since the stripping blade is generally constituted by a very thin metal strip, a blade holder is required for the fastening. This locks the stripping blade in relation to the blade holder, in particular in relation to the clamping element.

A blade holder can possess a profile which only allows the use of a specific stripping blade having a corresponding mating profile.

In this way, basically similarly constructed blade bars can be used, for instance, on diverse roller mill types, for which respectively different stripping blades are necessary. For each roller mill type a profile of the blade bar insert is chosen, so that only the correct stripping blade having the corresponding mating profile can be used.

The object of the invention is additionally achieved by a stripping system for stripping product from a roller in a rolling mill, comprising a blade bar as described above, comprising a blade holder and comprising a stripping blade.

The stripping blade can be connected, in particularly non-releasably, to the blade holder, so that both parts can together be rolled up, mounted and inserted into the blade bar.

Preferably, the stripping blade and the blade holder exist as separate parts.

The object of the invention is additionally achieved by a stripping system for applying a stripping blade to a roller, in particular as described above, wherein the stripping blade is pneumatically or hydraulically fixable in the stripping system.

The stripping system serves to strip product from a roller in a rolling mill.

The object of the invention is additionally achieved by a method for fastening a stripping blade in a stripping system, in particular as described above, wherein a retaining force is generated on the stripping blade, characterized in that the retaining force is generated hydraulically or pneumatically.

The object of the invention, is additionally achieved by a use of a sealing element, in particular an O-ring, in a blade bar as described above.

The stripping blade suffers constant wear and must be regularly exchanged. For this, the pneumatic or hydraulic pressure is on each occasion changed and the sealing element subjected to load or relieved of load. After some time, the squeezing and unloading of the sealing element leads to wear and tear, so that the sealing element must be exchanged.

Preferably, to this end, the hydraulic or pneumatic supply is decoupled from the blade bar, the blade bar insert is removed from the basic element, and the sealing element or sealing elements is/are exchanged.

An exchange of the sealing element or sealing elements can also become necessary if a thinner or thicker stripping blade is due to be used and a larger or smaller gap has to be bridged.

The invention is explained in greater detail below in illustrative embodiments on the basis of drawings, wherein:

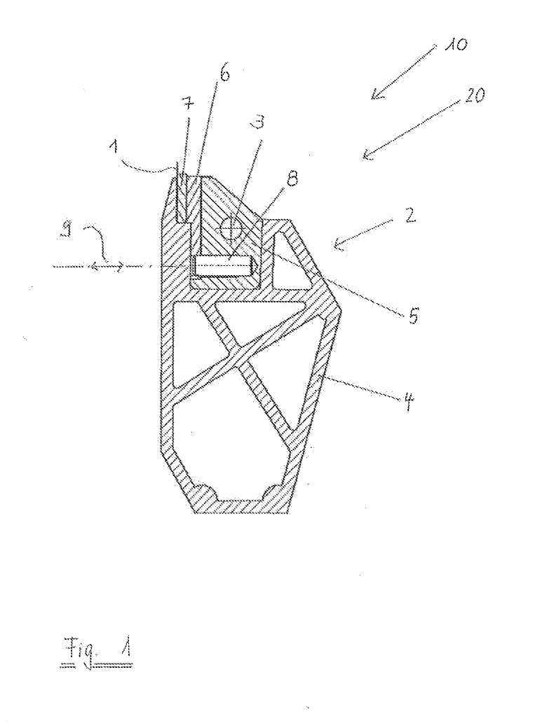

FIG. 1 shows a first sectional representation of an example of a stripping system according to the invention;

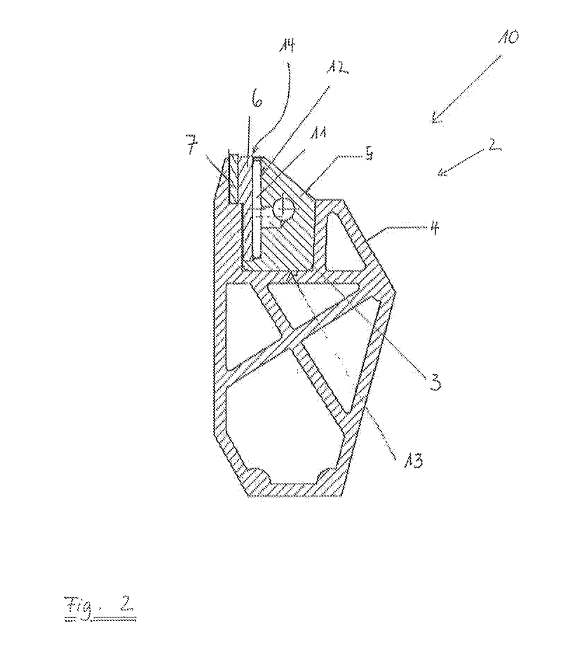

FIG. 2 shows a second sectional representation of the same stripping system;

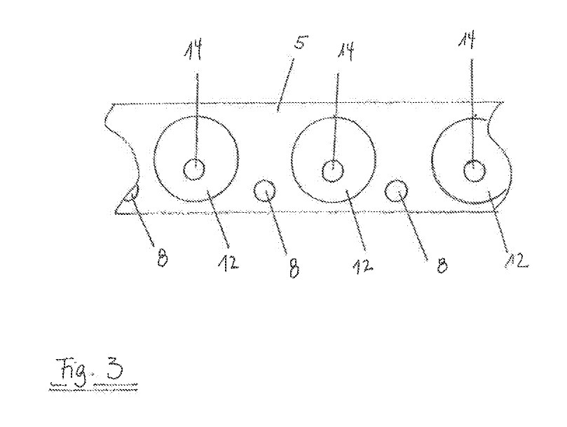

FIG. 3 shows a side view of a first example of a blade bar insert;

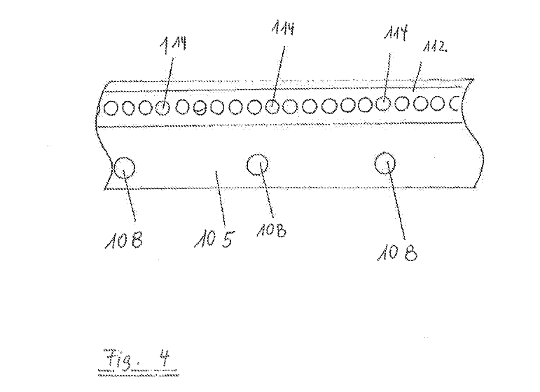

FIG. 4 shows a side view of a second example of a blade bar insert;

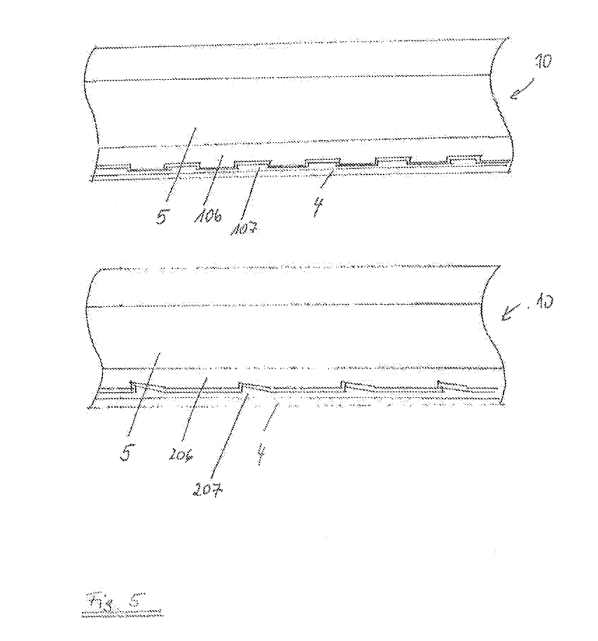

FIG. 5 shows top views of examples of stripping systems having various blade holder/clamping element combinations.

FIG. 1 shows a first sectional representation of an example or a stripping system 10 according to the invention for applying a striping blade 1 to a roller (not explicitly shown in the figure).

The stripping system 10 comprises a blade holder system 20 and a stripping blade 1.

The blade holder system 20 comprises a blade bar 2, which has a line 3 for conducting a fluid by means of which a pneumatic or hydraulic pressure for fastening the stripping blade 1 to the blade bar 2 can be built up.

In the shown example, the line is a compressed air line which can be connected to a compressed air supply (not explicitly shown). By means of a compressed air control system (likewise not explicitly shown), a pressure can be built up in the line 3 with the use of compressed air.

The blade bar 2 comprises a basic element 4 and a blade bar insert 5. The basic element 4 is constructed as an extruded body from aluminum.

The line 3 for conducting the compressed air is disposed in the blade bar insert 5.

The blade bar 2 further comprises a clamping element 6, which, under the influence of the pneumatic force, is movable in relation to the blade bar insert 5. The clamping element 6 couples the pneumatic force on the blade holder 7 and in this way fixes the stripping blade 1 to the blade bar 2.

In the blade bar insert 5 are provided pins 8, on which the clamping element 6 is guidable, so that in particular a movement of the clamping element is possible only in the axial direction 9 of the pins 8.

FIG. 2 shows a second sectional representation of the same stripping system 10.

The basic element 4 has a groove-like opening 13, into which the blade bar insert 5, the clamping element 6 and the blade holder 7 can be placed. The material thicknesses are coordinated such that a gap 14 of about 0.5 mm exists between blade bar insert 5 and clamping element 6.

The blade bar 2 comprises sealing elements 11, in the present case O-rings. The sealing elements bridge the gap 14 between blade bar insert 5 and clamping element 6 and in the mounted stare are compressed, so that the stripping system is in a pretensioned state. The production-related tolerances, which lead to a gap size of up to about 0.25 mm between blade holder 7 and basic element 4, are now still to be bridged.

This is realized by a flow of compressed air into the line 3 and a build-up of pneumatic pressure. The clamping element 6 is pressed against the blade holder 7. Between blade bar insert 5 and clamping element 6 is formed a gap, which is bridged by the expanding seals 11, Upon the build-up of the pneumatic pressure, the seals II prevent the escape of compressed air from the blade bar 2 and the intake of rolling stock into the blade bar 2.

The sealing elements 11 are disposed in depressions 12 provided in the blade bar insert 5.

FIG. 3 shows a side view of a first example of a blade bar insert 5.

On the blade bar insert 5 are provided pins 8, which serve to guide the clamping element (not explicitly shown in the figure). The blade bar insert 5 has round depressions 12, which are respectively disposed around an opening 14 of the line system. Into the depressions 12, O-rings (not explicitly represented) can be placed as the sealing element.

FIG. 4 shows a side view of a further example of a blade bar insert 105.

On the blade bar insert. 105 are provided pins 108, which serve to guide the clamping element (not explicitly shown in the figure). The blade bar insert 105 has a groove-like depression 112, in which openings 114 of the line system are disposed. Into the depression 112 can be placed a strip-like sealing element (not explicitly represented).

FIG. 5 shows top views of stripping systems in which, in the blade bar insert 5, various combinations of respectively fitting clamping inserts 106; 206 and blade holders 107; 207 are used.

1-15. (canceled)

16. A blade bar for a stripping system for applying a stripping blade to a roller, wherein at least one pressure element is provided, which is disposed within the blade bar and is designed such that the pressure element can assume a first state, in which the pressure element can help to exert a clamping force for fixing of the stripping blade in the blade bar, and a second state, in which the pressure element does not help to exert the clamping force,
the blade bar has a line for conducting a fluid, by which a pneumatic or hydraulic pressure for fastening the stripping blade to the blade bar can be built up, and/or
a plurality of pressure elements are provided, which are coupled with one another so that the plurality of pressure elements can be transferred substantially simultaneously from the first into the second state and from the second into the first state.

17. The blade bar according to claim 16, wherein the position and/or the extent of the pressure element in a direction of the clamping force is variable.

18. The blade bar according to claim 18, wherein the blade bar is connectable to a compressed air or hydraulic supply for creation of a pneumatic or hydraulic pressure.

19. The blade bar according to claim 16, wherein the blade bar is connectable to a compressed air or hydraulic control system.

20. The blade bar according to claim 16, wherein the blade bar comprises a basic element and a blade bar insert.

21. The blade bar according to claim 20, wherein a line for conducting a fluid is disposed in the blade bar insert.

22. The blade bar according to claim 16, wherein the blade bar comprises a pressure element in a form of a clamping element which, under the influence of a pneumatic or hydraulic force which can be built up via a fluid in the line is movable.

23. The blade bar according to claim 22, wherein at least one guide element, on which the clamping element is movably guidable.

24. The blade bar according to claim 23, wherein a movement of the clamping element is possible only in or counter to a direction of the clamping force.

25. The blade bar according to claim 23, wherein at least one pin is provided so that a movement of the clamping element is possible only in or counter to an axial direction of the pin.

26. The blade bar according to claim 16, wherein the blade bar comprises at least one sealing element which, upon the build-up of hydraulic or pneumatic pressure, the sealing element prevents escape of fluid from the blade bar.

27. The blade bar according to claim 28, wherein the sealing element is an O-ring.

28. The blade bar according to claim 28, wherein the sealing element seals a gap between a clamping element and a blade bar insert or between the clamping element and a basic element.

29. A blade bar for a stripping system for applying a stripping blade to a roller, wherein the blade bar is constructed at least partially of a lightweight construction.

30. The blade bar according to claim 29, wherein the blade bar is constructed at least partially as an extruded body.

31. The blade bar according to claim 29, wherein the blade bar comprises a basic element which is constructed of a lightweight construction.

32. The blade bar according to claim 16, wherein the blade bar consists at least partially of aluminum, an aluminum alloy or a fiber composite.

33. A blade holder system for a stripping system for stripping product from a roller in a rolling mill for applying a stripping blade to a roller, comprising a blade bar according to claim 16 and comprising a blade holder.

34. A blade holder system for a stripping system for stripping product from a roller in a rolling mill for applying a stripping blade to a roller, comprising a blade bar according to claim 29 and comprising a blade holder.

35. A stripping system for stripping product from a roller in a rolling mill, comprising a blade bar according to claim 16, comprising a blade holder and comprising a stripping blade.

36. A stripping system for stripping product from a roller in a rolling mill, comprising a blade bar according to claim 29, comprising a blade holder and comprising a stripping blade.

37. A stripping system for applying a stripping blade to a roller in order to strip product from a roller in a rolling mill, according to claim 38, wherein the stripping blade is pneumatically or hydraulically fixable in the stripping system.

38. A method for fastening a stripping blade in a stripping system, wherein a retaining force is generated on the stripping blade, and the retaining force is generated hydraulically or pneumatically.

39. The method according to claim 38, wherein a sealing element prevents an escape of fluid from the blade bar upon build-up of hydraulic or pneumatic pressure.

40. The method according to claim 39, wherein the sealing element is an O-ring.

41. The method according to claim 39, wherein a gap between a clamping element and a clamping bar insert or between the clamping element and a basic element is sealed.
